(19) United States
(12) Patent Application Publication
(10) Pub. No.: US 2021/0380831 A1
(43) Pub. Date: Dec. 9, 2021

(54) COLOR DEVELOPMENT WRITING COMPOSITIONS AND WRITING INSTRUMENTS

(71) Applicant: Crayola LLC, Easton, PA (US)

(72) Inventors: Keith J. Allison, Blandon, PA (US); Victor Hugo Bedoya, Easton, PA (US)

(73) Assignee: Crayola LLC, Easton, PA (US)

(21) Appl. No.: 17/410,310

(22) Filed: Aug. 24, 2021

Related U.S. Application Data
(63) Continuation-in-part of application No. 15/976,181, filed on May 10, 2018.
(60) Provisional application No. 62/555,922, filed on Sep. 8, 2017.

(51) Int. Cl. C09D 11/50; C09D 11/17; B43K 19/14

(52) U.S. Cl. CPC C09D 11/50; B43K 19/145; C09D 11/17

(57) ABSTRACT

Writing compositions capable of undergoing a color development when brought into contact with a specific substrate including a color change-inducing compound are provided. Writing instruments comprising such writing compositions are also provided. Application of the writing compositions to surfaces other than the intended substrate will avoid color development and prevent staining of the unintended surfaces. The writing compositions include at least one filler; at least one leuco dye; at least one lipid including at least one wax, at least one fatty acid, at least one fatty acid ester; an antioxidant; and optionally at least one additive.

### CROSS REFERENCE TO RELATED APPLICATIONS

This application is a continuation in part of and claims priority to U.S. application Ser. No. 15/976,181, filed May 10, 2018, which claims priority to U.S. Provisional Application No. 62/555,922, filed Sep. 8, 2017, both of which are incorporated by reference herein, in their entireties and for all purposes.

### FIELD OF THE INVENTION

The present invention relates generally to writing compositions for use as marking or coloring materials. More specifically, the present invention relates to writing compositions for use with specific marking substrates in systems such that stray marks of color are prevented from appearing on unintended surfaces.

### BACKGROUND OF THE INVENTION

Art materials for the entertainment and developmental benefit of children are well-known. For example, drawing and writing materials, such as pencils and crayons, are typically given to children to produce artwork and to stimulate the children's creativity and imagination. To contribute to a pleasant use experience for children, pencils and crayons must be capable of smooth laydown and high intensity or vibrancy of the resulting colored markings. Pencils and crayons must also be sufficiently flexible and resist breakage such that they can be used by children without snapping. With respect to crayons, other beneficial characteristics are the ability to blend and layer various colors to create color composite effects and the ability to vary shades.

Unfortunately, a significant drawback related to typical crayons and colored pencils is that when used by children, they often contribute to messy staining and marking of unintended objects, such as carpets, furniture, walls, or clothing. As a result, adults are often hesitant to provide such crayons and colored pencils to children to avoid potential stains of unintended surfaces.

Thus, there exists a need for writing or marking compositions that prevent formation of stains on surfaces unintended for marking and that develop marks or color only when applied to an intended substrate or surface for marking. Particularly, there exists a need for writing compositions that are substantially non-staining or marking on unintended objects such as carpets, furniture, walls, and clothing, but can generate a varied range of colors when used in conjunction with and applied to an intended substrate.

### SUMMARY OF THE INVENTION

An embodiment of the present invention provides writing compositions that impart colored marks to an intended substrate, but avoid staining unintended objects to which they are applied, such as clothing or carpet. The writing compositions comprise at least one filler; at least one leuco dye, at least one lipid selected from fatty acids, fatty acid esters, or waxes; at least one premature color masking agent comprising at least one of titanium dioxide and an antioxidant and optionally at least one additive (e.g., solvents, preservatives, scents, glitter).

The writing compositions are capable of developing vibrant color upon application to or contact with a substrate having a color change-inducing compound. The substrate's color change-inducing compound is capable of initiating a color change in the leuco dye within the writing compositions.

A further embodiment of the present invention provides writing instruments (e.g., crayons) comprising writing compositions according to the present invention.

### DETAILED DESCRIPTION OF THE INVENTION

The present invention relates to writing compositions capable of undergoing a color development when brought into contact with a specific substrate having a color change-inducing compound. Suitable substrates are described in U.S. Pat. No. 6,124,377, which is incorporated herein by reference for all purposes. The substrate includes a treated surface having a coating comprising a color change-inducing compound or developer. The substrate is coated in specific locations where color development is desired, while other locations have no coating to prevent color development. The color change-inducing compound interacts chemically with a color precursor/colorant present in the writing compositions (e.g., a leuco dye) to produce a chromophore that results in a visible color forming in or on the substrate.

The color change-inducing compound is preferably acidic, or includes acidic functional groups. For example, if the color precursor/colorant is a leuco dye, the color change-inducing compound may be a Lewis acid. Desirable Lewis acids include, but are not limited to, zinc-containing resins, certain clays, or phenolic resins. The Lewis acid causes a rearrangement of the leuco dye molecule, which results in the development of a chromophore of intense color.

The coating of the substrate may also include one or more binders for retaining the coating components on the substrate. Color formed on the substrate is not easily transferred from the substrate to unintended surfaces. Apart from the specific substrate including a color change-inducing compound, application of the writing compositions to unintended surfaces will resist developing color or will not result in color development or staining of the unintended surfaces.

The coating of the substrate may include a liquid vehicle (e.g., water) into which constituents of the coating are mixed to facilitate application of the coating to the substrate surface. The coating may also include one or more binders (e.g., clay, polymeric binder), a color change-inducing compound (e.g., a phenolic resin), one or more void cell formers (e.g., calcium carbonate), and one or more additives (defoamers, color retardants, surfactants, buffers). An exemplary coating composition is provided in Table 1:

TABLE 1
Example Coating Mixture

| | | Weight |
|---|---|---|
| Component | Function | Percentage (wt %) |
| Water | Vehicle | 28.54 |
| Surfynol PC | Defoamer | 0.06 |
| Surfynol 104A | Surfactant | 0.06 |
| ASP NC Kaolin Clay | Clay | 24.29 |
| Calcium Carbonate | Opacifying filler | 1.6 |
| Ansilex 93 Slurry | Clay-TiO₂ mixture | 13.18 |
| Ecokote 4361 | Polymeric binder | 11.86 |
| Durez 33446 | Phenolic resin/color | 20.41 |
| | developer | |
| TOTAL | | 100 |

The writing compositions may be injection molded into different shapes (e.g., pencils, crayons). The writing compositions comprise at least one filler, at least one leuco dye, at least one lipid selected from fatty acids, fatty acid esters, waxes, and mixtures thereof; at least one premature color masking agent; and optionally at least one additive.

It has been surprisingly found that the compositions produce resilient yet strong writing instruments capable of being used to apply markings to a suitable substrate's surface with minimally protective, supportive sheaths or coverings of rigid material to prevent breakage. The compositions may also be applied to objects and surfaces lacking a suitable color-development substrate without staining or marking the objects or surfaces. The compositions of the present invention include dyes (i.e., leuco dyes) which have minimal or no color prior to coming into contact with a color-change or color-development compound within a suitable substrate. Thus, the compositions of the present invention may be inadvertently applied to an unintended object or surface, for example, by a child, without the dyes leaving a mark. The writing compositions will only develop vibrantly colored markings when brought into contact with an intended substrate including the desired color-development compound. The substrate may be applied to paper.

An embodiment of a writing composition may include at least one suitable filler. The filler may include a mineral filler (e.g., calcium carbonate), or suitable micas. Other non-limiting examples of suitable mineral fillers are clays, such as kaolin clay or bentonite clay, talc, silica, wollastonite, glass beads, alumina trihydrate, calcium sulfate fibers, zinc oxide, dolomite, barium sulfate, magnesium trihydrate, diatomaceous earth, magnetite, hematite, halloysite, and mixtures thereof. The filler may include polymer beads, such as solid, hollow or foamed polymer beads. The filler may include starches such as cornstarch, arrowroot starch, potato starch, and the like. The filler may provide stiffness and strength to the writing compositions to resist bending and breaking. The compositions of the present invention may include filler in any suitable amount. Preferably, the filler is present in an amount between about 3% and 25% by weight of the composition. More preferably, the filler is present in an amount between about 5% and 20% by weight. Even more preferably, the filler is present in an amount between about 10% and 15% by weight.

The compositions also include a colorant (i.e., a leuco dye). The leuco dye or mixture of leuco dyes may be brought into contact with the specific substrate having a coating including a color change-inducing compound to develop color. The coating may be applied to any location on the substrate where color is desired; the substrate may lack the coating in other locations where color is not desired so as to impede color development in those locations on the substrate. Additionally, the leuco dye or mixture thereof does not develop vibrant color when applied to other, unintended surfaces in the absence of the substrate and its coating having the color change-inducing compound. The colorant/dye may have no color or only minimal color in the absence of contact with a color change-inducing compound. The colorant/dye can be present in the writing compositions in any suitable amount. Preferably, the colorant is present from about 0.1% to about 5% by weight of the writing composition. More preferably, the colorant is present from about 0.5% and 3% by weight of the writing composition. Even more preferably, the colorant is present in an amount of between about 1% and 2% by weight of the writing composition.

The writing compositions of the present invention also include at least one lipid. The lipids may be selected from at least one of fatty acids (e.g., stearic acid), fatty acid esters (e.g., alkyl hydroxystearoyl stearate di-C20-40 alkyl dimer dilinoleate, myristyl myristate, soybean oil methyl ester, vegetable oil alkyl esters), fatty amides (e.g., dialkyl stearamides, oleamides, ceramides), or waxes (e.g., paraffin wax, soy wax, microcrystalline wax, beeswax, synthetic beeswax). In certain embodiments, the at least one lipid may include a combination of waxes, fatty acids, and fatty acid esters. The at least one lipid may serve to disperse the colorant (e.g., leuco dye) throughout the compositions and to soften the compositions to improve the transfer of compositional constituents, such as the colorant, to the substrate. The at least one lipid is preferably included in an amount between about 60% and 95% by weight of the composition. More preferably, the at least one lipid is included in an amount between about 77% and 93% by weight of the composition. Even more preferably, the at least one lipid is included in an amount between about 80% and 90% by weight of the composition.

The wax or combination of waxes may be present in any suitable amount. The waxes may include paraffin wax, beeswax, synthetic beeswax, waxes prepared from vegetable oils such as but not limited to soy wax, and mixtures thereof. A wax or a combination of waxes is preferably included in an amount between about 30% and about 65% by weight of the composition. More preferably, the wax or combination of waxes is present in an amount between about 40% and 60% by weight of the composition. Even more preferably, the wax or combination of waxes is present in an amount between about 50% and 55%. Preferably, the compositions include combinations of synthetic beeswax, and paraffin wax. Preferably, paraffin wax is included in an amount of between about 15% and about 45% by weight of the composition. Preferably, synthetic beeswax is present in an amount between about 0.1% and about 10% by weight. Preferably, synthetic beeswax is present in an amount between about 1% and about 5% by weight.

The fatty acids may be present in any suitable amount. The fatty acids may include oleic acid and/or stearic acid. A fatty acid or combination of fatty acids is preferably included in an amount between 20% and about 50% by weight of the composition. More preferably, the fatty acid or combination of fatty acids is present in an amount between about 20% and 60% by weight of the composition. Even more preferably, the fatty acid or combination of fatty acids is present in an amount between about 30% and 50% by weight of the composition.

In certain embodiments, the compositions include stearic acid. Preferably, stearic acid is present in an amount of between about 25% and about 45% by weight of the composition.

In certain embodiments, fatty acid esters and/or fatty amides may be present in any suitable amount. The fatty acid esters and/or fatty amides may include isobutyl stearate, C18-38 alkyl hydroxystearoyl stearate, C20-40 alkyl dimer dilinoleate, vegetable oil alkyl esters such as soybean oil methyl ester, myristyl myristate, dialkyl stearamides, and/or oleamides. A fatty acid ester, fatty amide, or any combination thereof is preferably included in an amount between 0.1% and about 25% by weight of the composition. More preferably, the fatty acid ester, fatty amide, or combination thereof is present in an amount between about 1% and 20% by weight of the composition. Even more preferably, the fatty acid ester, fatty amide, or combination thereof is present in an amount between about 5% and 15% by weight of the composition.

The writing compositions of the present invention also comprise at least one antioxidant. The antioxidant may be present in any suitable amount in the compositions. Non-limiting examples of suitable antioxidants are hindered phenolics, such as certain of the Irganox® antioxidants available from BASF. Irganox® 1135 (octyl 3-[4-hydroxy-3,5-di(propan-2-yl)phenyl]propanoate), Irganox® 1035(2-[2-[3-(3,5-ditert-butyl-4-hydroxyphenyl)propanoyloxy]ethylsulfanyl]ethyl 3-(3,5-ditert-butyl-4-hydroxyphenyl)propanoate) and Irganox® 1010 [pentaerythritol tetrakis(3-(3,5-di-tert-butyl-4-hydroxyphenyl)propionate)] are especially suitable. Other non-limiting examples of suitable antioxidants are organophophites (such as Irgafos® 168), BHT (butylated hydroxytoluene) and analogues thereof. Secondary aromatic amines, such as alkylated-diphenylamine may be used. Alpha-tocopherol may also be used. Blends of antioxidants may also be used, such as blends of primary and secondary antioxidants. Preferably, the antioxidants are present in an amount between about 0.1% and 10% by weight of the composition. More preferably, the antioxidant is present in an amount between about 0.5% and 5% by weight of the composition. Even more preferably, the antioxidant is present in an amount between about 1% and 3% by weight of the composition. Mixtures of antioxidants are also suitable.

According to certain embodiments, writing compositions of the present invention include optional additives. These additives may include, but are not limited to, process aids, antimicrobial agents also referred to as preservatives, solvents, scents, pearlescent agents and glitter. In particular embodiments, the compositions of the present invention comprise between about 0.05% and about 5% by weight additive(s). Other particular embodiments of the compositions comprise between about 0.5% and about 3% by weight additives. Further particular embodiments of the compositions include between about 1% and 2% by weight.

Such additives are readily available from numerous sources. One or more preservatives, such as anti-microbial agents and fungicides, can be added to increase the shelf life of the compositions according to the present invention. Some examples of preservatives include Fungitrol® 940, Kathon® LX, Nuosept® 95, Acticide® LA, and Polyphase® P100. Process aids, such as Hydropalat® 44, can be added to aid in mixing of the components. A scent or fragrance may also be added to the composition.

According to an embodiment, the writing composition comprises, consists essentially of, or consists of at least one leuco dye, at least one color change masking agent selected from at least one of titanium dioxide and an antioxidant, and at least one lipid. In another embodiment of the present invention, the writing composition comprises, consists essentially of, or consists of: stearic acid; paraffin wax; C18-38 alkyl hydroxystearoyl stearate; di-C20-40 alkyl dimer dilinoleate; myristyl myristate; soybean oil methyl ester; benzenepropanoic acid, 3,5-bis (1,1-dimethyl-ethyl)-4-hydroxy-C7-C9 branched alkyl esters (hindered phenolic antioxidant); and leuco dye. The writing composition may further include a filler, such as calcium carbonate.

The compositions produced according to embodiments of the invention set forth herein may also be formed into any shape suitable for a writing instrument, including into crayon shapes by injection molding into crayon stick shapes. The crayons provide users with the ability to layer applications of the writing compositions on the coating of the substrate, allowing for blending of the color-development effect between different leuco dyes. Additionally, the crayon shape provides superior control over the amount of writing composition and colorant deposited on the substrate, which allows a user to vary the shade of the color that develops. Crayons produced from the compositions according to embodiments of the invention herein may be covered or wrapped in supportive sheaths or coatings. The sheaths may be made of paper.

As used herein, a percentage (%) refers to a weight percentage of the composition, unless indicated otherwise. The term “Lbs.” as used herein refers to an amount in pounds of all components in the total composition.

The embodiments of the invention are described above using the term “comprising” and variations thereof. However, it is the intent of the inventors that the term “comprising” may be substituted in any of the embodiments described herein with “consisting of” and “consisting essentially of” without departing from the scope of the invention.

The following examples are provided to describe the invention in greater detail and are intended to illustrate, not limit, the invention.

### EXAMPLES

While exemplary compositions are set forth below, alternative compositions will be apparent to those skilled in the art. Such artisans will be able to modify the compositions with an eye toward the desired performance properties and intended use.

Exemplary writing compositions according to certain embodiments of the invention herein are shown in Table 2. The components were added and blended until substantial homogeneity was achieved to result in the writing compositions depicted in Table 2. The order of mixing may be modified as needed. Each composition includes a different leuco dye such that the marks produced by each respective composition when brought into contact with the substrate result in a different color as displayed below.

TABLE 2
Exemplary Writing Compositions

| | | | | | | | | Dark |
|---|---|---|---|---|---|---|---|---|
| | Green | Purple | Red | Orange | Yellow | Blue | Violet | Green |
| Component | (Wt %) | (Wt %) | (Wt %) | (Wt %) | (Wt %) | (Wt %) | (Wt %) | (Wt %) |
| Stearic acid | 33.51 | 33.51 | 33.51 | 33.51 | 33.62 | 33.62 | 33.51 | 33.51 |
| Paraffin Wax | 39.38 | 39.38 | 39.38 | 39.38 | 39.52 | 39.52 | 39.38 | 39.38 |
| C18-38 Alkyl | 1.58 | 1.58 | 1.58 | 1.58 | 1.58 | 1.58 | 1.58 | 1.58 |
| Hydroxystearoyl | | | | | | | | |
| Stearate or | | | | | | | | |
| Synthetic | | | | | | | | |
| Beeswax | | | | | | | | |
| Di-C20-40 Alkyl | 2.66 | 2.66 | 2.66 | 2.66 | 2.66 | 2.66 | 2.66 | 2.65 |
| Dimer | | | | | | | | |
| Dilinoleate | | | | | | | | |
| (Kester Wax ® | | | | | | | | |
| K82D) | | | | | | | | |
| Myristyl | 2.66 | 2.66 | 2.66 | 2.66 | 2.66 | 2.66 | 2.65 | 2.66 |
| Myristate | | | | | | | | |
| (Liponate ™ MM) | | | | | | | | |
| Calcium | 13.30 | 13.30 | 13.30 | 13.30 | 13.34 | 13.34 | 13.30 | 13.30 |
| Carbonate | | | | | | | | |
| (filler) | | | | | | | | |
| Soybean oil | 3.46 | 3.46 | 3.46 | 3.46 | 3.47 | 3.46 | 3.46 | 3.46 |
| methyl ester | | | | | | | | |
| (SoyClear ®) | | | | | | | | |
| Irganox 1135 | 1.86 | 1.86 | 1.86 | 1.86 | 1.87 | 1.86 | 1.86 | 1.86 |
| Antioxidant | | | | | | | | |
| (benzenepropanoic | | | | | | | | |
| acid, 3,5-bis | | | | | | | | |
| (1,1-dimethyl- | | | | | | | | |
| ethyl)-4- | | | | | | | | |
| hydroxy-C7-C9 | | | | | | | | |
| branched alkyl | | | | | | | | |
| esters.) | | | | | | | | |
| Leuco Dye | 1.43 | — | — | 1.06 | 1.28 | — | — | — |
| Yellow | | | | | | | | |
| Leuco Dye | — | — | 1.19 | 0.53 | — | — | — | — |
| Orange | | | | | | | | |
| Leuco Dye Red | — | 1.04 | 0.40 | — | — | — | — | — |
| Leuco Dye Blue | — | — | — | — | — | 0.44 | — | — |
| Leuco Dye Green | — | — | — | — | — | — | — | 1.60 |
| Leuco Dye Cyan | 0.16 | 0.55 | — | — | — | 0.86 | — | — |
| Leuco Dye Violet | — | — | — | — | — | — | 1.60 | — |
| TOTAL | 100.0 | 100.0 | 100.0 | 100.0 | 100.0 | 100.0 | 100.0 | 100.0 |

### Table 3—Further Exemplary Writing Compositions

Exemplary writing compositions according to certain embodiments of the invention herein are shown in Table 3. The components were added and blended until substantial homogeneity was achieved to result in the writing compositions depicted in Table 3. The order of mixing may be modified as needed.

TABLE 3

| Component | Percentage by Weight (wt %) |
|---|---|
| Stearic Acid | 33.5 |
| Paraffin Wax | 39.5 |
| Synthetic Beeswax | 1.6 |
| Fatty acid esters | 8.5 |
| Calcium Carbonate | 13.4 |
| Hindered Phenolic Antioxidant | 1.9 |
| Leuco Dye | 1.6 |
| Total | 100 |

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

What is claimed:

1. A writing composition for use with a substrate having a color-development coating, the composition comprising:
at least one leuco dye;
at least one lipid comprising at least one wax, at least one fatty acid, and at least one fatty acid ester; and
at least one premature color masking agent comprising at least one of an antioxidant or titanium dioxide.

2. The writing composition of claim 1, wherein the at least one premature color masking agent comprises at least one antioxidant.

3. The writing composition of claim 1, further comprising at least one filler.

4. The writing composition of claim 3, wherein the at least one filler comprises a mineral filler.

5. The writing composition of claim 3, wherein the at least one filler comprises calcium carbonate.

6. The writing composition of claim 1, wherein the composition further comprises at least one additive comprising preservatives, solvents, process aids, scents, and glitter.

7. The writing composition of claim 6, wherein the at least one additive comprises a preservative.

8. The writing composition of claim 6, wherein the at least one additive is present in an amount between about 0.05 wt % and about 5 wt %.

9. The writing composition of claim 1, wherein the at least one wax comprises at least one of paraffin wax, or synthetic beeswax or a mixture thereof.

10. The writing composition of claim 9, wherein the at least one wax comprises:
paraffin wax present in an amount between about 20 wt % and about 50 wt %; and
synthetic beeswax present in an amount between about 0.1 wt % and about 10 wt %.

11. The writing composition of claim 1, wherein the at least one fatty acid is present in an amount between about 20 wt % and about 50 wt %.

12. The writing composition of claim 1, wherein the at least one fatty acid comprises stearic acid.

13. The writing composition of claim 1, wherein the at least one fatty acid ester comprises di-C20-40 alkyl dimer dilinoleate and myristyl myristate present in an amount between about 0.1 wt % and about 10 wt %.

14. The writing composition of claim 1, wherein:
the at least one leuco dye is present in an amount between about 0.1 wt % to about 5 wt %;
the one or more lipids are present in an amount between about 60 wt % and about 95 wt %; and
the color change masking agent comprising at least one of titanium dioxide and an antioxidant is present in an amount between about 0.1 wt % and about 10 wt %.

15. The writing composition of claim 14, wherein the color change masking agent comprises the antioxidant.

16. The writing composition of claim 14, further comprising at least one filler present in an amount between about 3 wt % and about 25 wt %.

17. The writing composition of claim 15, wherein:
the at least one leuco dye is present in an amount between about 0.5 wt % and about 3 wt %;
the one or more lipids are present in an amount between about 77 wt % and about 93 wt %; and
the antioxidant is present in an amount between about 0.5 wt% and about 5 wt %.

18. The writing composition of claim 17, further comprising at least one filler present in an amount between about 5 wt % and about 20 wt %.

19. A writing instrument comprising the writing composition of claim 1.

20. The writing instrument of claim 19, wherein the writing instrument is produced via injection molding.

21. The writing instrument of claim 19, wherein the writing instrument is encased within a sheath or covered in a protective coating layer.

22. The writing instrument of claim 19, wherein the sheath comprises paper.

23. The writing instrument of claim 19, wherein the writing instrument is in a crayon shape.

24. The writing instrument of claim 19, wherein the writing instrument is sheathed in paper.
